(19) United States
(12) Patent Application Publication
(10) Pub. No.: US 2026/0172175 A1
(43) Pub. Date: Jun. 18, 2026

(54) UNIFORM AND NON-UNIFORM SRS SUBSAMPLING AND INPAINTING

(71) Applicant: Samsung Electronics Co., Ltd., Suwon-si (KR)

(72) Inventors: Xinliang Zhang, Plano, TX (US); Young Han Nam, Plano, TX (US); Tiexing Wang, Melissa, TX (US); Fan Zhang, Frisco, TX (US); Yang Li, Plano, TX (US)

(21) Appl. No.: 19/232,842

(22) Filed: Jun. 9, 2025

Related U.S. Application Data
(60) Provisional application No. 63/735,102, filed on Dec. 17, 2024.

(51) Int. Cl. H04L 5/00

(52) U.S. Cl. CPC H04L 5/0048

(57) ABSTRACT

A user equipment (UE) includes a transceiver, and a processor operably coupled to the transceiver. The transceiver is configured to receive, from a base station (BS), sounding reference signal (SRS) configuration information, the SRS configuration information including SRS subsampling configuration information, and receive, from the BS, a trigger to transmit an SRS. The processor is configured to, in response to receipt of the trigger to transmit the SRS, generate an SRS subsampling pattern based on the SRS configuration information, generate a subsampled SRS signal based on the SRS subsampling pattern, and cause the transceiver to transmit, to the BS, the subsampled SRS signal.

### CROSS-REFERENCE TO RELATED APPLICATION AND CLAIM OF PRIORITY

This application claims priority under 35 U.S.C. § 119(e) to U.S. Provisional Patent Application No. 63/735,102 filed on Dec. 17, 2024. The above-identified provisional patent application is hereby incorporated by reference in its entirety.

### TECHNICAL FIELD

This disclosure relates generally to wireless networks. More specifically, this disclosure relates to uniform and non-uniform sounding reference signal (SRS) subsampling and inpainting.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for uniform and non-uniform SRS subsampling and inpainting.

In one embodiment, a user equipment (UE) is provided. The UE includes a transceiver, and a processor operably coupled to the transceiver. The transceiver is configured to receive, from a base station (BS), sounding reference signal (SRS) configuration information, the SRS configuration information including SRS subsampling configuration information, and receive, from the BS, a trigger to transmit an SRS. The processor is configured to, in response to receipt of the trigger to transmit the SRS, generate an SRS subsampling pattern based on the SRS configuration information, generate a subsampled SRS signal based on the SRS subsampling pattern, and cause the transceiver to transmit, to the BS, the subsampled SRS signal.

In another embodiment, a BS is provided. The BS includes a transceiver, and a processor operably coupled to the transceiver. The transceiver is configured to transmit, to a UE, SRS configuration information, the SRS configuration information including SRS subsampling configuration information, and transmit, to the UE, a trigger to transmit an SRS. The transceiver is also configured to receive, from the UE, a subsampled SRS signal generated by the UE based on the SRS configuration information. The processor is configured to extract SRS resources included in the subsampled SRS signal, perform channel estimation on the extracted SRS resources, and inpaint channel state information (CSI) for SRS resources not included in the subsampled SRS signal. The processor is also configured to generate full band CSI of the UE based on a result of the channel estimation on the extracted SRS resources and the inpainted CSI.

In yet another embodiment, a method of operating a UE is provided. The method includes receiving, from a BS, SRS configuration information, the SRS configuration information including SRS subsampling configuration information, and receiving, from the BS, a trigger to transmit an SRS. The method also includes, in response to receipt of the trigger to transmit the SRS, generating an SRS subsampling pattern based on the SRS configuration information, generating a subsampled SRS signal based on the SRS subsampling pattern, and transmitting, to the BS, the subsampled SRS signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates example antenna beamforming architecture according to embodiments of the present disclosure;

FIG. 5 illustrates an example SRS configuration according to embodiments of the present disclosure;

FIG. 6 illustrates an example AI-based SRS inpainting framework according to embodiments of the present disclosure;

FIG. 7 illustrates an example procedure for AI-based SRS inpainting according to embodiments of the present disclosure;

FIG. 8 illustrates an example of SRS CSI inpainting using MAE according to embodiments of the present disclosure;

FIGS. 9A-9F illustrate example SRS subsampling patterns according to embodiments of the present disclosure;

FIG. 10 illustrates an example of SRS subsampling configuration for an SRS resource according to embodiments of the present disclosure;

FIG. 11 illustrates another example of SRS subsampling configuration for an SRS resource according to embodiments of the present disclosure;

FIG. 12 illustrates another example of SRS subsampling configuration for an SRS resource according to embodiments of the present disclosure;

FIG. 13 illustrates another example of SRS subsampling configuration for an SRS resource according to embodiments of the present disclosure;

FIG. 14 illustrates an example procedure for AI-based SRS inpainting from a pseudo random non-uniform pattern according to embodiments of the present disclosure;

FIG. 15 illustrates an example of pseudo random pattern generation for subcarrier level subsampling according to embodiments of the present disclosure;

FIG. 16 illustrates an example of pseudo random pattern generation for subband-level or patch level subsampling according to embodiments of the present disclosure;

FIG. 17 illustrates an example method for SRS subsampling according to embodiments of the present disclosure; and

FIG. 18 illustrates an example method for SRS subsampling and inpainting according to embodiments of the present disclosure.

### DETAILED DESCRIPTION

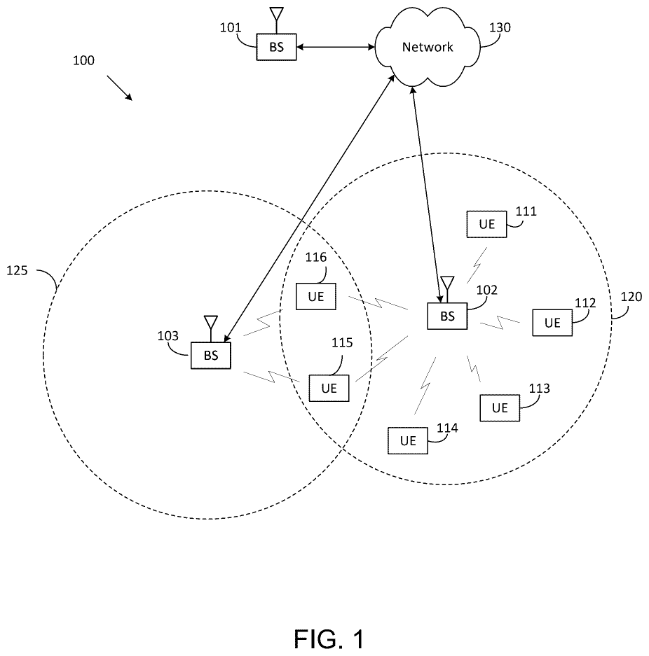

FIGS. 1 through 18, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for uniform and non-uniform SRS subsampling and inpainting. In certain embodiments, one or more of the gNBs 101-103 includes circuitry, programing, or a combination thereof, to support uniform and non-uniform SRS subsampling and inpainting in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

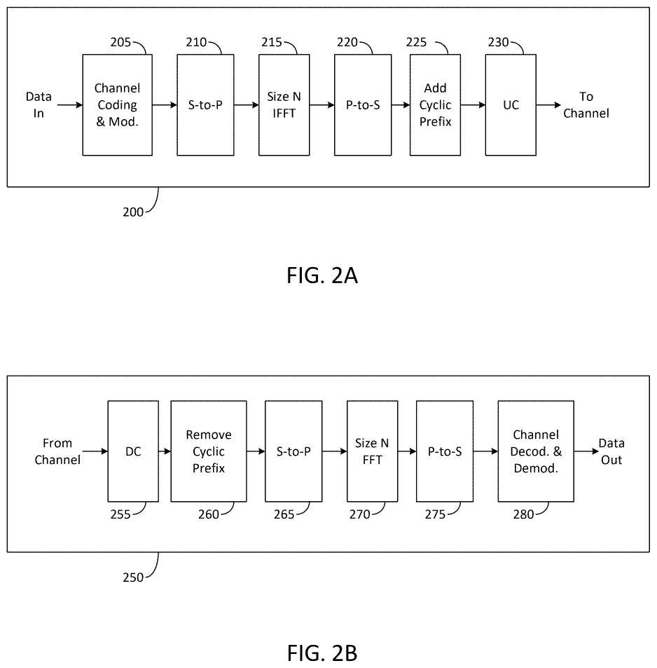

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support uniform and non-uniform SRS subsampling and inpainting as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

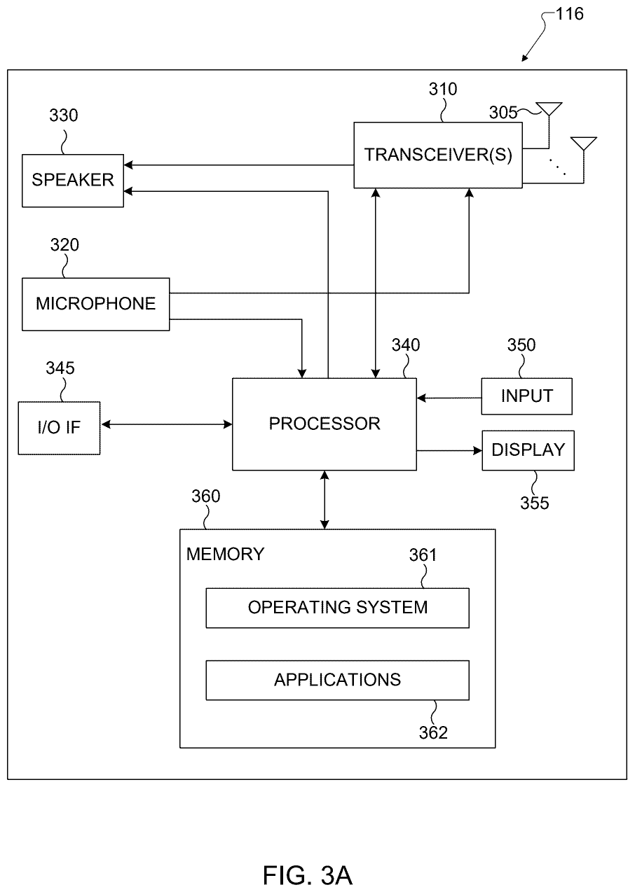

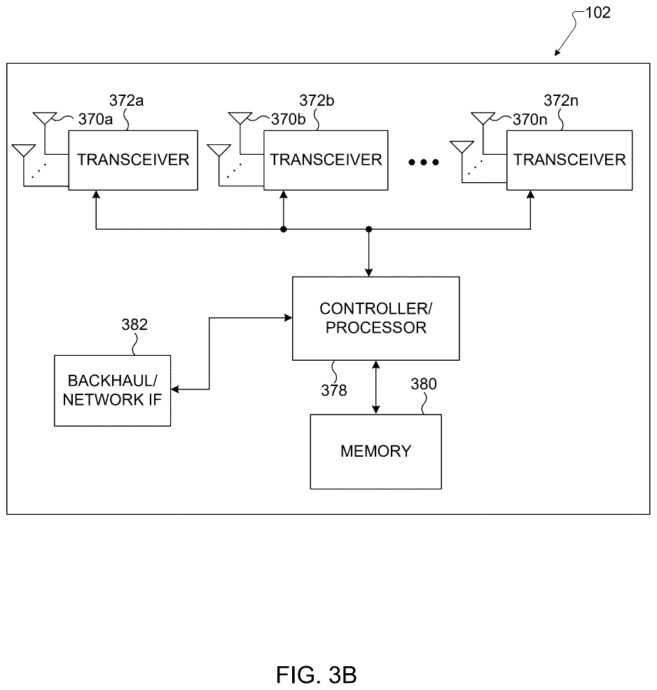

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for uniform and non-uniform SRS subsampling and inpainting as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372 a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support uniform and non-uniform SRS subsampling and inpainting as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

Rel.13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports will remain more or less the same.

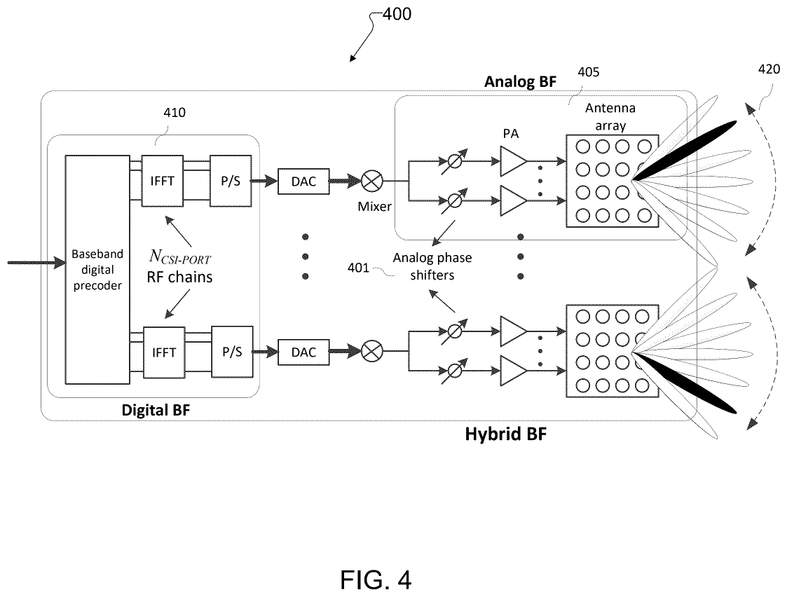

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated by beamforming architecture 400 in FIG. 4.

FIG. 4 illustrates example antenna beamforming architecture 400 according to embodiments of the present disclosure. The embodiment of the antenna beamforming architecture illustrated in FIG. 4 is for illustration only. Different embodiments of an antenna beamforming architecture could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks.

Although FIG. 4 illustrates one example antenna beamforming architecture 400, various changes may be made to FIG. 4. For example, various components in FIG. 4 could be combined, further subdivided, or omitted and additional components could be added according to particular needs.

In 5G New Radio (NR), the Sounding Reference Signal (SRS) play a critical role in uplink (UL) communication, enabling the network to assess the channel quality and perform advanced operations like channel estimation, beam management, and scheduling. The SRS is highly configurable to meet diverse use cases, thanks to the SRS's flexibility in both the time and frequency domains.

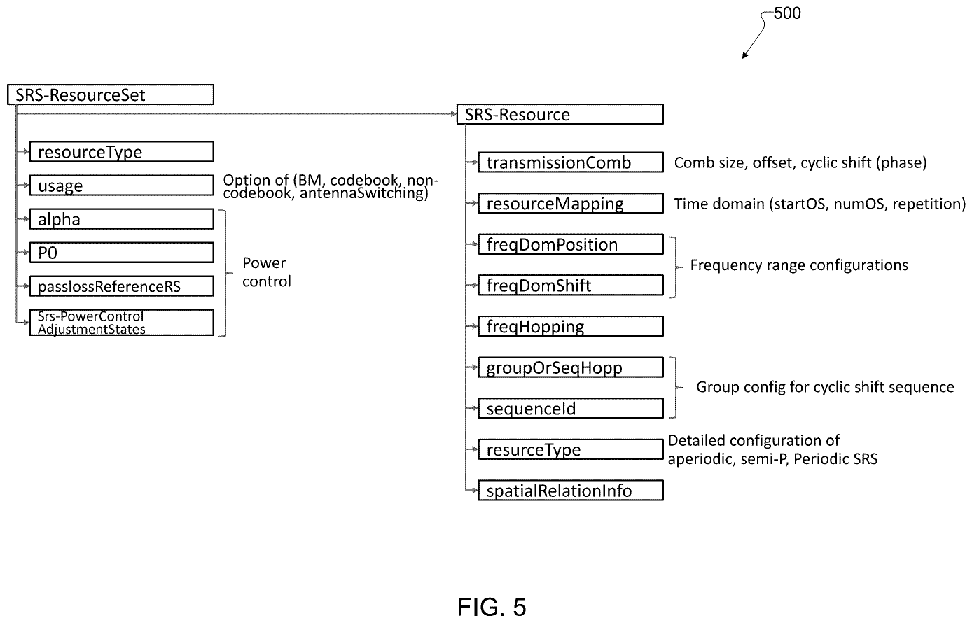

The configuration of the SRS in 5G NR is managed through the RRC (Radio Resource Control) layer, where the configuration is organized into two main components: SRS-ResourceSet and SRS-Resource, as illustrated in FIG. 5.

FIG. 5 illustrates an example SRS configuration 500 according to embodiments of the present disclosure. The embodiment of an SRS configuration of FIG. 5 is for illustration only. Different embodiments of an SRS configuration could be used without departing from the scope of this disclosure.

In the example of FIG. 5, SRS-ResourceSet defines the broader group of resources. Key parameters of SRS-ResourceSet include:
resourceType: Configurations such as Aperiodic (AP), Semi-Persistent (semi-P), and Periodic SRS transmissions.
usage: Supports multiple functionalities, including beam management, codebook-based transmissions, non-codebook usage, and antenna switching.
Power Control: Managed through parameters like alpha, P0, and passlossReferenceRS, with additional control via Srs-PowerControlAdjustmentStates.

SRS-Resource specifies detailed characteristics of each SRS resource. Core parameters of SRS-Resource include:
transmissionComb: Configures comb size, offset, and cyclic shift (phase) to facilitate efficient resource allocation.
resourceMapping: Controls time domain aspects such as the start symbol, number of symbols, and repetition factor.
freqDomPosition and freqDomShift: Define the frequency domain position and shifts within the bandwidth part (BWP).
freqHopping: Allows frequency hopping configurations across resource blocks (RBs).
groupOrSeqHopp and sequenceId: Enable group and sequence-based cyclic shift configurations.
resourceType: Mirrors the periodicity and offset options found in the SRS-ResourceSet.
spatialRelationInfo: Supports spatial relationships for beam-based SRS transmission.

Although FIG. 5 illustrates one example SRS configuration 500, various changes may be made to FIG. 5. For example, additional configuration parameters could be included, one or more of the configuration parameters may be excluded, etc. according to particular needs.

The robust configuration framework illustrated in FIG. 5 allows the SRS to adapt to varying network conditions, bandwidth allocations, and antenna schemes, enabling 5G NR to deliver enhanced performance in UL coverage, beamforming, and resource management.

SRS is an expensive resource due to SRS's overhead and UE power consumption. The scheduling of SRS tends to be conservative by network operators in order to provide balance among UL overhead, UE power consumption, and SRS-CSI's contribution on DL precoding, UL port reduction, etc. (which leads to a limited ratio that SRS is configured in a practical network). This results in a high threshold of scheduling SRS and limits the usage of SRS. A balance is desirable between overhead reduction and SRS contributions such as DL precoding performance improvement.

When compared to channel state information-reference signal (CSI-RS) based methods, SRS has high overhead when a high number of SRS resources are requested. For example, in high UE density scenarios, each UE configured with SRS transmission utilizes a dedicated SRS resource for a subband or across the full band. For UEs with multiple antenna ports, the CSI of all the antenna ports may be requested through SRS transmission. The UE may transmit an SRS in different SRS resources using different antenna ports. In a hybrid MIMO system, each UE configured with SRS transmission should send SRS in repetition, so that the BS is able to select one beam from multiple analog beams.

Enlarging the frequency comb size could be a naïve way of reducing the SRS overhead. However, given a desired bandwidth to sound, there is a trade-off of frequency comb size. A large comb (low density sampling) covers a wide BW and fits more UEs, but the delay domain can result in aliasing. The number of cyclic shifts will further restrict the delay range of each SRS resource. A small comb (high density sampling) covers a large range of delay without aliasing, but SRS tones have low power spectral density (PSD) and quality and support fewer UEs while maintaining the SRS overhead.

To provide a more efficient use of SRS resources while increasing utilization, various embodiments of the present disclosure provide a frequency domain subsampled SRS resource configuration and BS side artificial intelligence (AI)-based channel inpainting framework that results in an improved tradeoff between SRS overhead and full band SRS CSI accuracy.

In some embodiments, subsampling in either a uniform or non-uniform manner may be configured to reduce SRS overhead. In these embodiments, the SRS power may be boosted, which reduces the SRS scheduling threshold and extends SRS use cases. For example, a 1/4 subsampling ratio may yield 6 dB of SRS power boosting. The boosted power may be reflected in a reduction of the SRS scheduling threshold, such as RSRP.

In some embodiments, a patch-based subsampling pattern native to an AI-based channel inpainting may be utilized. This may enhance SRS CSI accuracy, further reduce the SRS scheduling threshold, and extend the application scenarios of SRS.

In some embodiments, backward compatible signaling for SRS subsampling configurations in 5G-beyond and 6G network systems with may be employed.

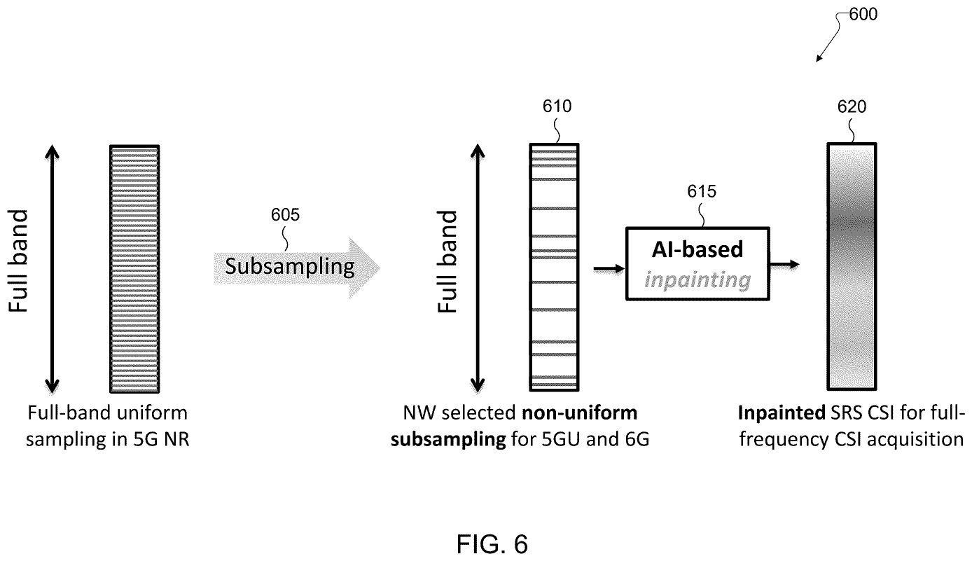

FIG. 6 illustrates an example AI-based SRS inpainting framework 600 according to embodiments of the present disclosure. The embodiment of AI-based SRS inpainting of FIG. 6 is for illustration only. Different embodiments of AI-based SRS inpainting could be used without departing from the scope of this disclosure.

In the example of FIG. 6, a BS (such as gNB 102 of FIG. 1) configures frequency domain subsampled SRS resources 605 for a UE (such as UE 116). After receiving the configuration, the UE transmits a subsampled SRS signal 610 based on the configuration. The subsampled SRS signal 610 has a reduced overhead and boosted per subcarrier power. After receiving the subsampled SRS signal 610, the BS performs channel inpainting 615 to recover SRS CSI of non-transmitted frequencies, resulting in inpainted SRS CSI 620.

Although FIG. 6 illustrates one example AI-based SRS inpainting framework 600, various changes may be made to FIG. 6. For example, various changes to the subsampling pattern could be made, etc. according to particular needs.

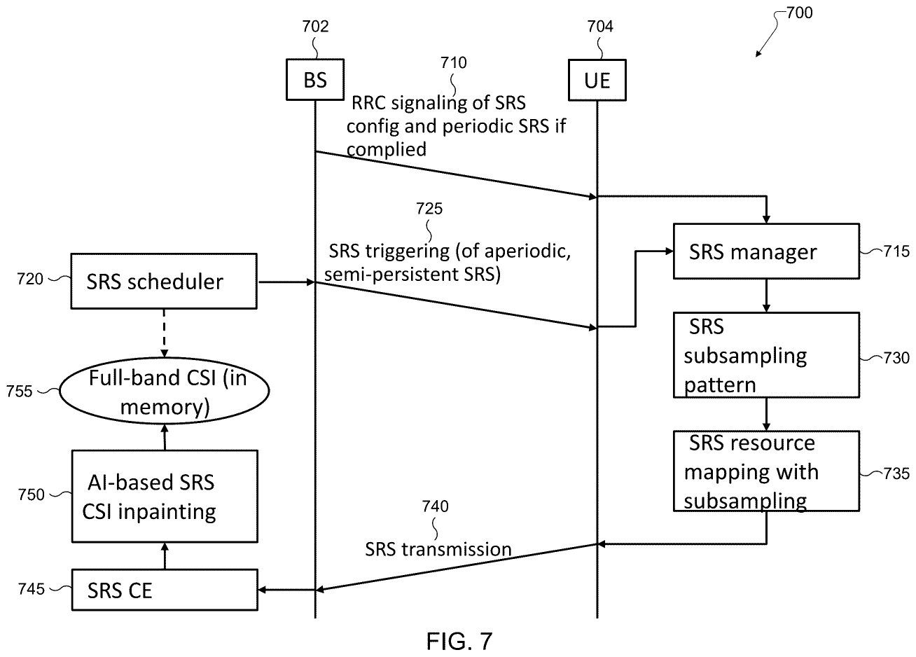

FIG. 6 illustrates a framework for AI-based SRS inpainting at a high level. FIG. 7 shows a procedure that implements an AI-based SRS inpainting framework such as shown in FIG. 6.

FIG. 7 illustrates an example procedure 700 for AI-based SRS inpainting according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for AI-based SRS inpainting could be used without departing from the scope of this disclosure.

In the example of FIG. 7, procedure 700 begins at operation 710. At operation 710, a BS 702 (which may be similar or identical to gNB 102 of FIG. 1) transfers (e.g., through RRC signaling) an SRS configuration and options including SRS subsampling to a UE 704 (which may be similar or identical to UE 116 of FIG. 1). In some embodiments, if appropriate, BS 702 may configure periodic SRS for UE 704 at operation 710.

At operation 715, UE 704 stores the SRS configuration (including the options including SRS subsampling). For example, in some embodiments, the UE 704 may store the SRS configuration in an SRS manager of UE 704.

At operation 720, an SRS scheduler of BS 702 determines the SRS transmission and configuration of a particular UE (i.e., UE 704).

At operation 725, BS 702 triggers or configures SRS transmission of a UE (i.e., UE 704) configured with an SRS subsampling configuration. The SRS transmission may be configured in an aperiodic, semi-persistent, or periodic manner.

At operation 730, UE 704 generates an SRS subsampling pattern according to the SRS configuration received from BS 702 at operation 710.

At operation 735, UE 704 generates a subsampled SRS signal for transmission to BS 702 based on the SRS subsampling pattern generated at operation 730.

At operation 740, UE 704 transmits the subsampled SRS signal generated at operation 735 to BS 702.

At operation 745, BS 702 extracts SRS from the subsampled SRS signal transmitted by UE 704 at operation 740 and performs channel estimation on the transmitted SRS resources.

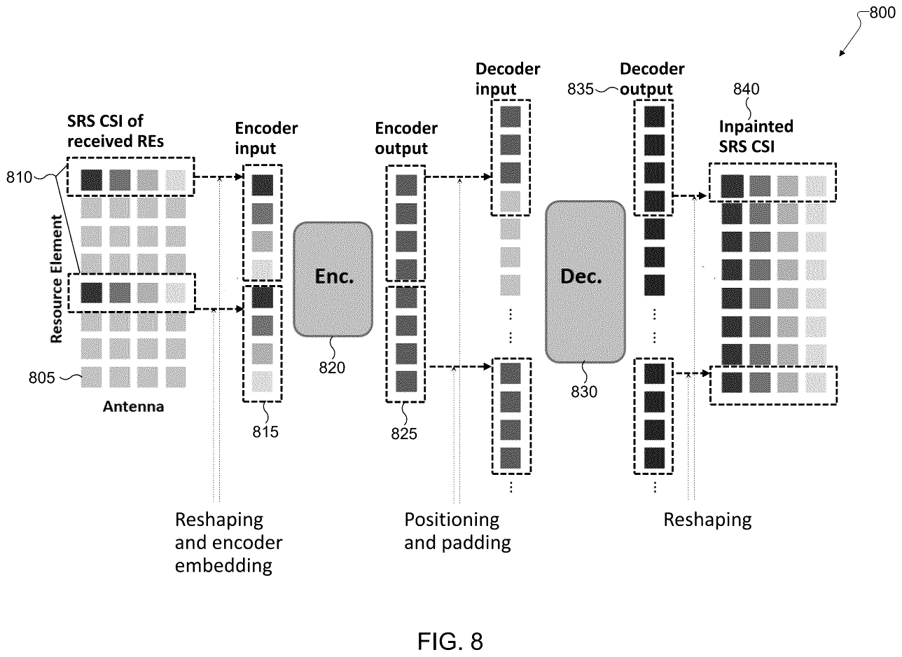

At operation 750, BS 702 performs SRS CSI inpainting. For example, in some embodiments, BS 702 may perform an AI-based inpainting such as masked-autoencoder, similar as described regarding FIG. 8. However, BS 702 is not limited to any particular SRS CSI inpainting scheme or technique at operation 750.

At operation 755, BS 702 obtains, from the SRS CSI inpainting at operation 750, the full-band CSI of the antenna port of the UE (i.e., UE 704) configured with an SRS subsampling configuration.

Although FIG. 7 illustrates one example procedure 700 for AI-based SRS inpainting, various changes may be made to FIG. 7. For example, while shown as a series of operations, various operations in FIG. 7 could overlap, occur in parallel, occur in a different order, occur any number of times, be omitted, or replaced by other operations.

As noted above, in some embodiments, a BS such as BS 702 of FIG. 7 may perform an AI-based inpainting such as masked-autoencoder (MAE) to perform SRS CSI inpainting. MAE refers to an autoencoding-approach that reconstructs an original signal given a partial observation (e.g., subsampled SRS signal in the case of the present disclosure). MAE utilizes an encoder that maps the observed signal to a latent representation, and a decoder that reconstructs the original signal from the latent representation. For example, an AI-based inpainting model based around MAE may be trained with full band SRS training data and/or subsampled SRS training data, and may utilize the training data to generate the inpainting for received subsampled SRS signals. An example of SRS CSI inpainting using MAE is shown in FIG. 8.

FIG. 8 illustrates an example of SRS CSI inpainting using MAE 800 according to embodiments of the present disclosure. The embodiment of SRS CSI inpainting using MAE of FIG. 8 is for illustration only. Different embodiments of SRS CSI inpainting using MAE could be used without departing from the scope of this disclosure.

In the example of FIG. 8, the example of SRS CSI inpainting using MAE 800 flows from left to right for a previously trained MAE based AI model. When the SRS CSI inpainting begins, the targeted full-band and full antenna port domain 805 is first patchified. The patchification is determined by the MAE design.

The transmitted SRS CSI patches 810 are embedded into a certain dimension domain 815 determined by the MAE encoder 820. The non-transmitted SRS CSI are not input to the MAE encoder.

The encoder 820 processes the transmitted patches 810 and outputs the patches in into a latent feature domain 825.

The patches in the latent feature domain 825 are positional embedded while the non-transmitted SRS CSI patches are padded (zero-padding for example), then both are input to the MAE decoder 830.

The MAE decoder 830 performs CSI inpainting of the non-transmitted SRS CSI patches and refines the CSI of transmitted patches. With reshaping the MAE decoder output 835, the inpainted SRS CSI 840 of the full-band for the full antenna port is obtained.

In MAE, the patch is the smallest unit decomposed from the full-band and full antenna port domain.

In some embodiments, the patch size may be 1-RE-by-1-antenna-port. In these embodiments, the full-band and full antenna port domain has the most granular representation, however, the MAE will have the highest complexity.

In some embodiments the patch size may be 1-RE-by-full-antenna-port, as shown in the example in FIG. 8.

In some embodiments, the patch size may be N-RE-by-M-antenna-port, as a general configuration.

In some embodiments, a patch may contain non-contiguous SRS CSI. For example, one patch may contain the 1^{st} and 3^{rd} subbands, and may be selected (i.e., used for the decoder), and the next patch may contain the 2^{nd} and 4^{th} subbands, but may not be selected.

In some embodiments, the transmitted SRS CSI patches 810 may be utilized to further train and/or refine the MAE based AI model.

Although FIG. 8 illustrates one example of SRS CSI inpainting using MAE 800, various changes may be made to FIG. 8. For example, various changes to patch size could be made, etc. according to particular needs.

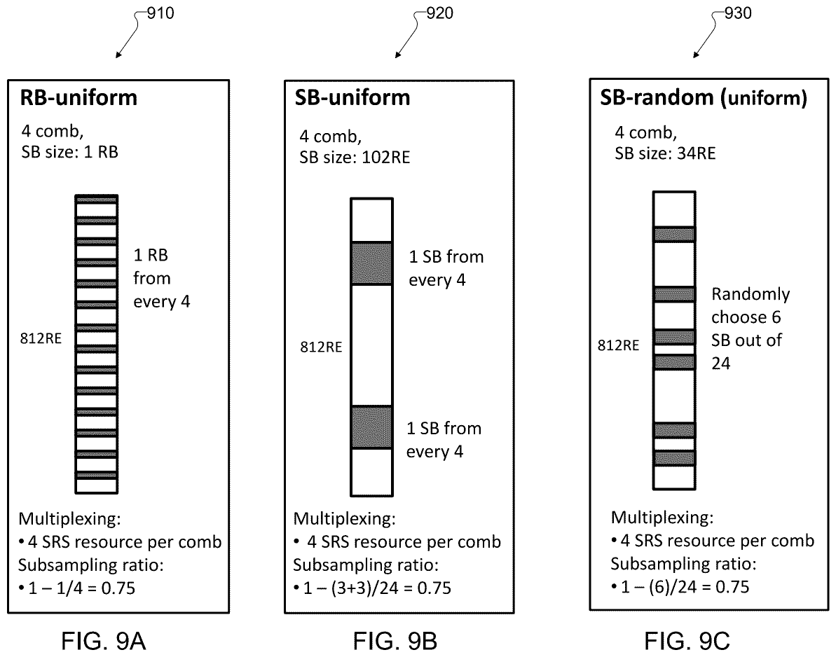

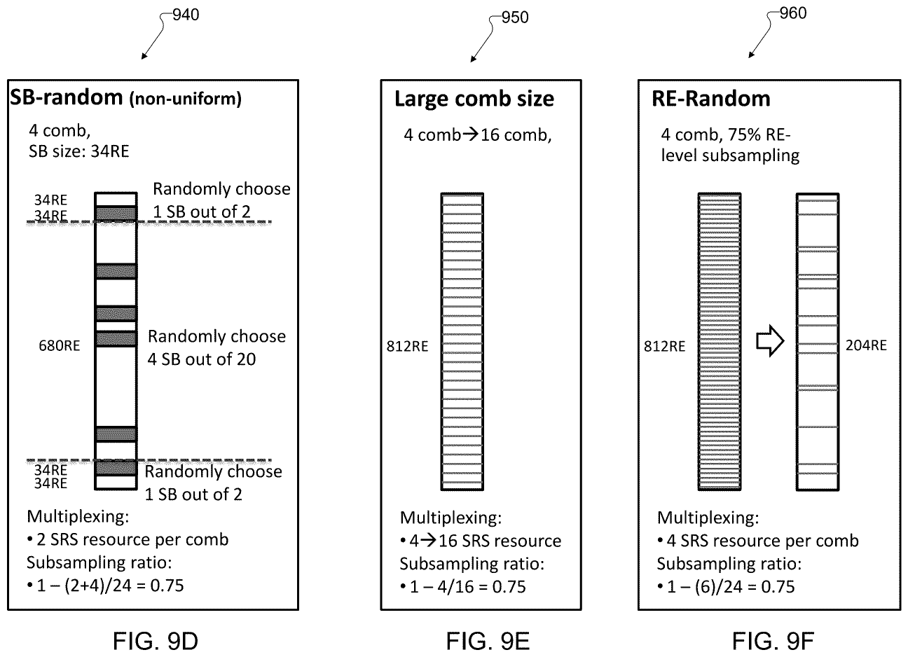

As noted above, in some embodiments, a BS (such as BS 702 of FIG. 7) may transfer an SRS configuration and options including SRS subsampling to a UE (such as UE 704 of FIG. 7) so that the UE may generate a subsampled SRS signal according to an SRS subsampling pattern. In some embodiments, the subsampling patterns may be uniform or non-uniform as shown in FIGS. 9A-9F.

FIGS. 9A-9F illustrate example SRS subsampling patterns 910-960 according to embodiments of the present disclosure. The embodiments of SRS subsampling patterns of FIGS. 9A-9F are for illustration only. Different embodiments of SRS subsampling patterns could be used without departing from the scope of this disclosure.

In the example of FIG. 9A, the SRS resource is uniformly subsampled in the frequency domain according to an “RB-uniform” SRS subsampling pattern 910. For SRS subsampling pattern 910, in each RB, the RE density is determined by the comb size. The RBs are subsampled in a uniform manner for the SRS to be transmitted.

The example of FIG. 9A assumes that a BS (such as BS 702 of FIG. 7) has Nₜ antenna ports on a full-band of 100 MHz, yielding 272 RBs. With comb size 4, the full-band contains 812 REs. With a subsampling ratio of 75%, (i.e., 1 RB from every 4 RBs are sampled) Up to 4 orthogonal SRS resources are configurable, with subsampling starting from a 1^{st}, 2^{nd}, 3^{rd}, or 4^{th} subband. The BS can decompose each configured subband into 1 patch with 3 RE and Nₜ antenna ports, or a smaller patch size.

In the example of FIG. 9B, the SRS resource is uniformly subsampled in the frequency domain according to an “SB-uniform” SRS subsampling pattern 920. For SRS subsampling pattern 920, the full band is decomposed into multiple subbands. In each subband, the RE density is determined by the comb size. The subbands are subsampled in a uniform manner for the SRS to be transmitted. The subbands can be defined based on the number of RBs or REs.

The example of FIG. 9B assumes that a BS (such as BS 702 of FIG. 7) has Nₜ antenna ports on a full-band of 100 MHz, yielding 272 RBs. With comb size 4, the full-band contains 812 REs. With a subband size of 34 REs, the full-band includes 24 subbands. With a subsampling ratio of 75%, (i.e., 1 subband from every 4 subbands is sampled), up to 4 orthogonal SRS resources are configurable, with subsampling starting from a 1^{st}, 2^{nd}, 3^{rd}, or 4^{th} subband. The BS can decompose each configured subband into 1 patch with 34 RE and Nₜ antenna ports, or a smaller patch size.

In the example of FIG. 9C, the SRS resource is pseudo-randomly subsampled in the frequency domain according to an “SB-random (uniform)” SRS subsampling pattern 930. For SRS subsampling pattern 930, the full band is decomposed into multiple subbands. In each subband, the RE density is determined by the comb size. The selected subbands for SRS transmission are configured through a pseudo-random procedure known by both the BS and the UE. The probability of a subband being selected is uniform across the full-band, or in different frequency regions (groups of subbands) the number of randomly selected subbands are different. The subbands can be defined based on the number of RBs or REs.

The example of FIG. 9C assumes that a BS (such as BS 702 of FIG. 7) has Nₜ antenna ports on a full-band of 100 MHz, yielding 272 RBs. With comb size 4, the full-band contains 812 REs. With a subband size of 34 REs, the full-band includes 24 subbands. With a subsampling ratio of 75% (i.e., 6 subbands are selected randomly from the 24 subbands), up to 4 orthogonal SRS resources are configurable, for example, by randomly selecting 6 from the available subbands 3 times and marking the selected subbands as unavailable. The BS can decompose each configured subband into 1 patch with 34 REs and Nₜ antenna ports, or a smaller patch size.

In the example of FIG. 9D, the SRS resource is pseudo-randomly subsampled in the frequency domain according to an “SB-random (non-uniform)” SRS subsampling pattern 940. For SRS subsampling pattern 940, the selected subbands for SRS transmission are configured through a pseudo-random procedure known by both the BS and the UE. The probability density of a certain subband being selected is a variable across the full-band. The subbands can be defined based on the number of RBs or REs.

The example of FIG. 9D assumes that a BS (such as BS 702 of FIG. 7) has Nₜ antenna ports on a full-band of 100 MHz, yielding 272 RBs. With comb size 4, the full-band contains 812 REs. With a subband size of 34 REs, the full-band includes 24 subbands. With a subsampling ratio of 75%, 6 subbands are selected randomly from the 24 subbands. However, there are some groups of subbands that have a higher subsampling ratio. For example, the middle of the full-band has an 80% subsampling ratio. There are also some groups of subbands that have a lower subsampling ratio. For example, the edges of the full-band have a 50% subsampling ratio. The number of orthogonal SRS resources is up to 4 with a 75% overall subsampling ratio. However, this depends on the variable subband density configuration. In the example of FIG. 9D, only 2 orthogonal SRS resources can be configured. The BS can decompose each configured subband into 1 patch with 34 RE and Nₜ antenna ports, or a smaller patch size.

In the example of FIG. 9E, the SRS resource is uniformly subsampled in the frequency domain according to a “Large comb size” SRS subsampling pattern 950. For SRS subsampling pattern 950, the SRS subsampling is achieved by an enlarged comb size. For example, the comb size may be equal to {6, 8, 12, 16, 24, etc.}.

The example of FIG. 9E assumes that a BS (such as BS 702 of FIG. 7) has Nₜ antenna ports on a full-band of 100 MHz, yielding 272 RBs. With comb size 16, the full-band contains 203 REs. The BS can decompose each configured subband into 1 patch with 34 REs and Nₜ antenna ports as in other examples described herein, or any patch size depending on the implementation.

In the example of FIG. 9F, the SRS resource is subsampled in the frequency domain at the RE level according to an “RE-Random” SRS subsampling pattern 960. For SRS subsampling pattern 960, the selected subbands for SRS transmission are configured through a pseudo-random procedure known by both the BS and the UE. The probability of a subband being selected is uniform or a variable across the full-band.

The example of FIG. 9F assumes that a BS (such as BS 702 of FIG. 7) has Nₜ antenna ports on a full-band of 100 MHz, yielding 272 RBs. With comb size 4, the full-band contains 812 REs. With a subsampling ratio of 75% (i.e., 203 REs are selected randomly from the 812 REs), up to 4 orthogonal SRS resources are configurable, for example, by randomly selecting 203 REs from the available REs 3 times and marking the selected REs as unavailable. The BS can decompose each subsampled SRS resource into one or multiple overlapped patches depending on the implementation.

Although FIGS. 9A-9F illustrate some example SRS subsampling patterns 910-960, various changes may be made to FIGS. 9A-9F. For example, various changes to comb size, the subsampling ratio, the bandwidth, etc. could be made according to particular needs.

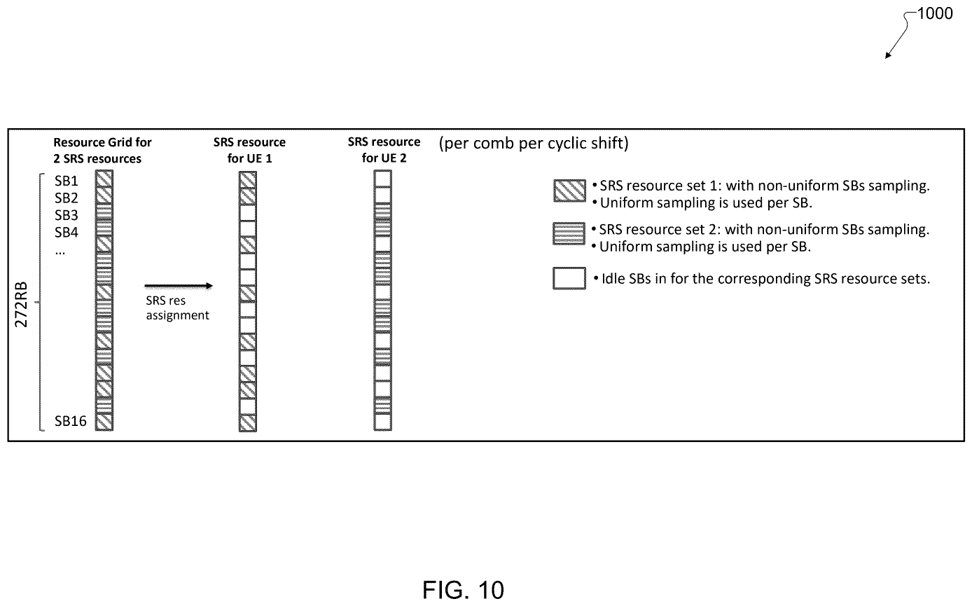

As noted above, in some embodiments, a BS (such as BS 702 of FIG. 7) may transfer an SRS configuration and options including SRS subsampling to a UE (such as UE 704 of FIG. 7) so that the UE may generate a subsampled SRS signal according to an SRS subsampling pattern (e.g., one of subsampling patterns 910-960 of FIGS. 9A-9F). In some embodiments, the subsampling pattern (e.g., a uniform or non-uniform subsampling pattern) may be signaled to the UE similar as described regarding one of FIGS. 10-13.

FIG. 10 illustrates an example 1000 of SRS subsampling configuration for an SRS resource according to embodiments of the present disclosure. The embodiment of SRS subsampling configuration for an SRS resource of FIG. 10 is for illustration only. Different embodiments of SRS subsampling configuration for an SRS resource could be used without departing from the scope of this disclosure.

In the example of FIG. 10, a BS (such as BS 702 of FIG. 7) configures SRS subsampling for an SRS resource configuration provided to a UE. In example 1000, the full-band is decomposed into N_{SB} subbands, where each of the subbands has the same bandwidth (except the marginal subband). No SRS is transmitted by a UE for the subbands that are not assigned in an SRS resource to that UE.

In some embodiments, the BS may configure the starting index resource block (RB) or subcarrier (SC) and the number of RBs or SCs in the SRS resource units. In these embodiments, the SRS resource configuration includes a list of selected SRS resource units, so that the UE is configured with one or multiple subbands.

In some embodiments, the BS may configure the subband size for SRS subsampling, (for example the number of RBs or SCs, for subband level SRS subsampling). In these embodiments, the SRS resource configuration includes a bitmap of selected subbands following the subband size configuration for SRS subsampling.

In some embodiments, the BS may configure a subsampling pattern generation associated to the SRS resource configuration. In these embodiments, the subsampling pattern can be uniform, group-uniform, random (uniform), etc. The subsampling pattern is regeneratable at the UE side based on the SRS resource configuration, thus the UE subsampling pattern is configured, and can be time variant if the subsampling pattern is time variant.

Although FIG. 10 illustrates one example 1000 of SRS subsampling configuration for an SRS resource, various changes may be made to FIG. 10. For example, various changes to number of SRS resources, etc. could be made according to particular needs.

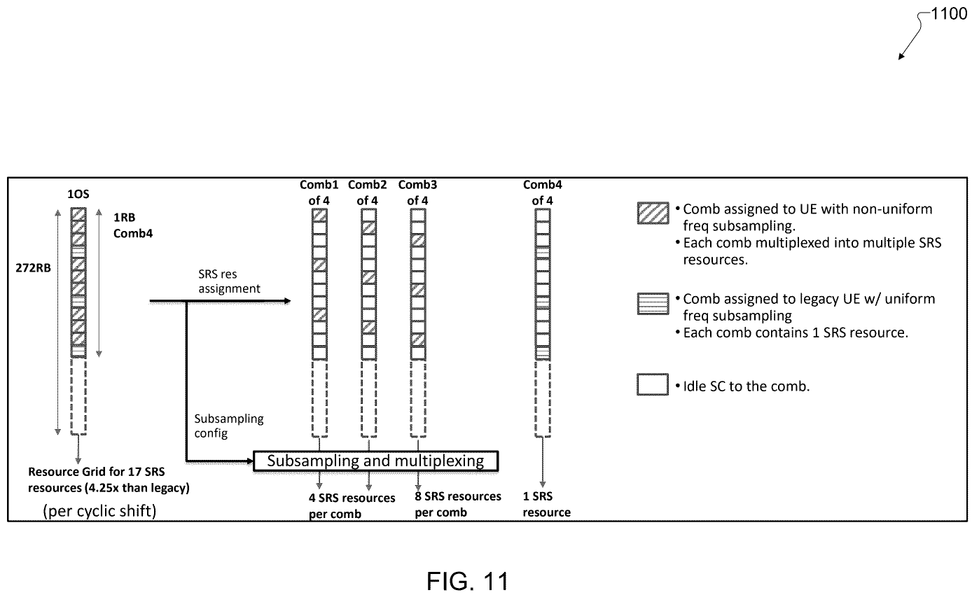

FIG. 11 illustrates another example 1100 of SRS subsampling configuration for an SRS resource according to embodiments of the present disclosure. The embodiment of SRS subsampling configuration for an SRS resource of FIG. 11 is for illustration only. Different embodiments of SRS subsampling configuration for an SRS resource could be used without departing from the scope of this disclosure.

In the example of FIG. 11, a BS (such as BS 702 of FIG. 7) configures SRS subsampling for an SRS resource configuration provided to a UE. In example 1100, the SRS resources are distinguished by comb. Some of the combs are configured to the UEs that have an enabled SRS subsampling capability (for example, 5G or 6G UEs), as the comb 1˜3 in FIG. 11, in which SRS subsampling can be performed. The other combs are configured to UEs that do not have or have disabled SRS subsampling capability (for example, legacy UEs), as the comb 4 in FIG. 11, in which SRS subsampling configuration is absent or ignored by the UEs.

In some embodiments, subband-level SRS subsampling may be configured on the combs for UEs that have an enabled SRS subsampling capability. In these embodiments, the subband-level SRS subsampling configuration may be employed similar as described regarding example 1000 of FIG. 10.

In some embodiments, the RE-level SRS subsampling may be configured on the combs for UEs that have an enabled SRS subsampling capability. In these embodiments, the BS may configure an RE subsampling bitmap of the configured comb for the SRS subsampling configuration. Alternatively, the BS may configure an RE-level subsampling pattern generation associated to the SRS resource. The subsampling pattern can be uniform, group-uniform, random (uniform), etc. The subsampling pattern is regeneratable at the UE side based on the SRS subsampling configuration, thus the UE subsampling pattern is configured, and can be time variant if the subsampling pattern is time variant.

Although FIG. 11 illustrates one example 1100 of SRS subsampling configuration for an SRS resource, various changes may be made to FIG. 11. For example, various changes to the number of combs, etc. could be made according to particular needs.

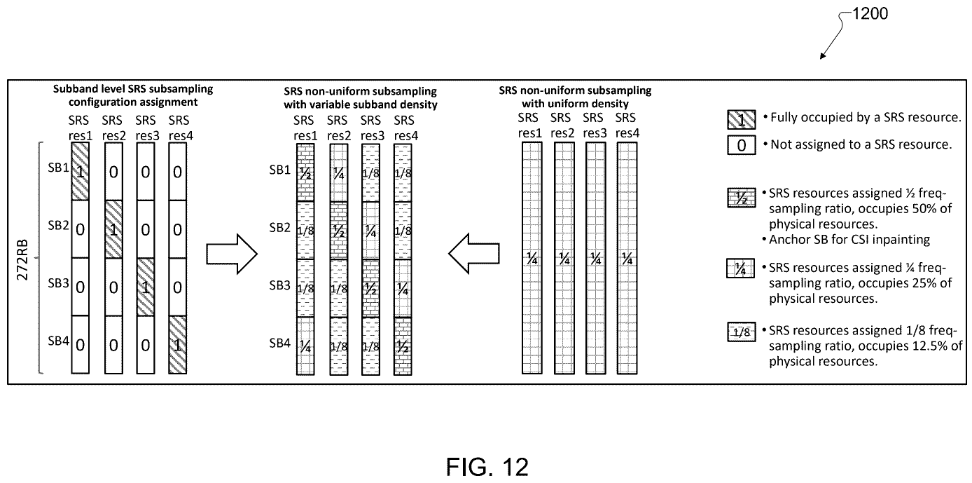

FIG. 12 illustrates another example 1200 of SRS subsampling configuration for an SRS resource according to embodiments of the present disclosure. The embodiment of SRS subsampling configuration for an SRS resource of FIG. 12 is for illustration only. Different embodiments of SRS subsampling configuration for an SRS resource could be used without departing from the scope of this disclosure.

In the example of FIG. 12, a BS (such as BS 702 of FIG. 7) configures SRS subsampling for an SRS resource configuration provided to a UE. In example 1200, the BS configures a different pattern or subsampling ratio to different subbands for a variable subband density.

In some embodiments different SRS resources have the same per subband subsampling density across the full-band. The per subband subsampling density is shared for all the orthogonal SRS resources that can be configured in the same OFDM symbol(s), as illustrated in FIG. 9D. The number of orthogonal SRS resources is determined by the subband with the lowest subsampling ratio (for example, 2 orthogonal SRS resources per comb per cyclic shift in example 1200).

In some embodiments, different SRS resources can have a different per subband subsampling density for each orthogonal SRS resource to be configured in the same OFDM symbol(s), as illustrated in FIG. 11. The number of orthogonal SRS resources can be improved from the embodiment of FIG. 11, because the subbands with the lowest subsampling ratio are different per SRS resource (for example, 4 orthogonal SRS resources per comb per cyclic shift in this example). Such a subband is treated as anchor subband for an accurate delay domain information estimation.

Although FIG. 12 illustrates one example 1200 of SRS subsampling configuration for an SRS resource, various changes may be made to FIG. 12. For example, various changes to the sampling ratios, etc. could be made according to particular needs.

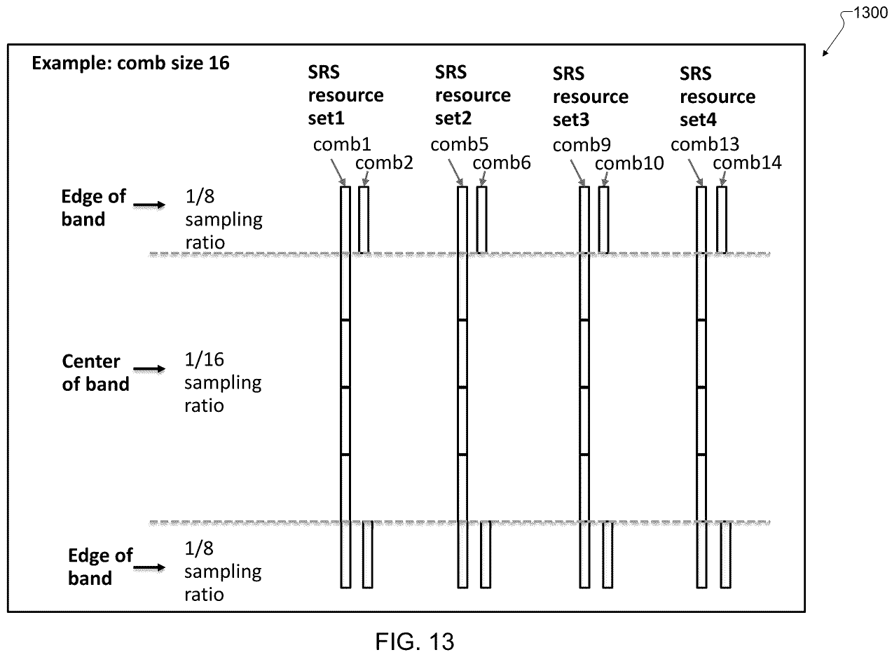

FIG. 13 illustrates another example 1300 of SRS subsampling configuration for an SRS resource according to embodiments of the present disclosure. The embodiment of SRS subsampling configuration for an SRS resource of FIG. 13 is for illustration only. Different embodiments of SRS subsampling configuration for an SRS resource could be used without departing from the scope of this disclosure.

In the example of FIG. 13, a BS (such as BS 702 of FIG. 7) configures SRS subsampling for an SRS resource configuration provided to a UE. In example 1300, the BS configures the UE with a large comb size, for example, the comb size may be {6, 8, 12, 16, 24, etc.}, compared to legacy networks where the comb size may only be {2, 4}. For legacy UEs, the BS can still configure a small comb size, (for example {2, 4}), while for UEs with large comb size capability (for example, a 6G UE), the BS can configure a large comb size with a selected index, so that the SRS resources for the legacy UE and 6G UE are orthogonal.

In some embodiments, the BS may configure one of the combs in the SRS resource with a uniform sampling ratio in the frequency domain.

In some embodiments, as shown in FIG. 13, the BS may configure one of the combs in the SRS resource in some subbands, and multiple of combs in other subbands. Therefore, the SRS resource has a variable subband density of subsampling. In these embodiments, the per subband combs assigned to the SRS resource may be shared to all the related SRS resources. The number of orthogonal SRS resources are determined by the subband with the highest number of assigned combs. Alternatively, for supporting an increased number of orthogonal SRS resources, each SRS resource can have a dedicated per subband combs assignment.

Although FIG. 13 illustrates one example 1300 of SRS subsampling configuration for an SRS resource, various changes may be made to FIG. 13. For example, various changes to the number of combs, the comb sizes, etc. could be made according to particular needs.

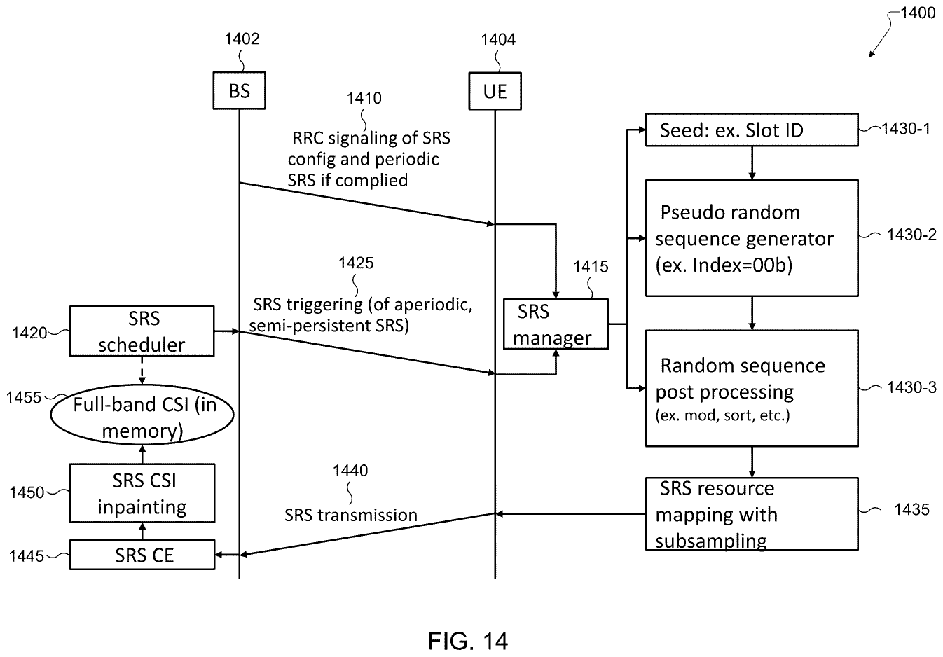

As noted above, in some embodiments, the subsampled SRS signal may employ a pseudo random non-uniform pattern. FIG. 14 shows a procedure for AI-based SRS inpainting that employs pseudo random non-uniform pattern generation as described herein.

FIG. 14 illustrates an example procedure 1400 for AI-based SRS inpainting from a pseudo random non-uniform pattern according to embodiments of the present disclosure. An embodiment of the procedure illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a procedure for AI-based SRS inpainting from a pseudo random non-uniform pattern could be used without departing from the scope of this disclosure.

In the example of FIG. 14, procedure 1400 begins at operation 1410. At operation 1410, a BS 1402 (which may be similar or identical to gNB 102 of FIG. 1) transfers (e.g., through RRC signaling) an SRS configuration including an indication of a non-uniform pattern for SRS subsampling to a UE 1404 (which may be similar or identical to UE 116 of FIG. 1). In some embodiments, if appropriate, BS 1402 may configure periodic SRS for UE 1404 at operation 1410. The non-uniform pattern is determined by a pseudo random sequence configured by BS 1402 for generation by UE 1404. The pseudo random sequence indicates the selection of subbands or subcarriers from non-subsampled SRS resources.

In some embodiments, the pseudo random sequence may be controlled by a pseudo random sequence generator. In these embodiments, the pseudo random sequence generator can be specified or indexed from one or more standard pseudo random sequence generators.

In some embodiments, the pseudo random sequence may be controlled by a seed for pseudo random sequence generation. In these embodiments, the seed for pseudo random sequence generation can be configured explicitly through the signaling, or a source to compute the seed may be configured, for example, using a slot ID or frame ID.

In some embodiments, if multiple pseudo random sequences are generated through one seed, the pseudo random sequence may be controlled by an index of an orthogonal sequence corresponding to multiple orthogonal SRS subsampling patterns.

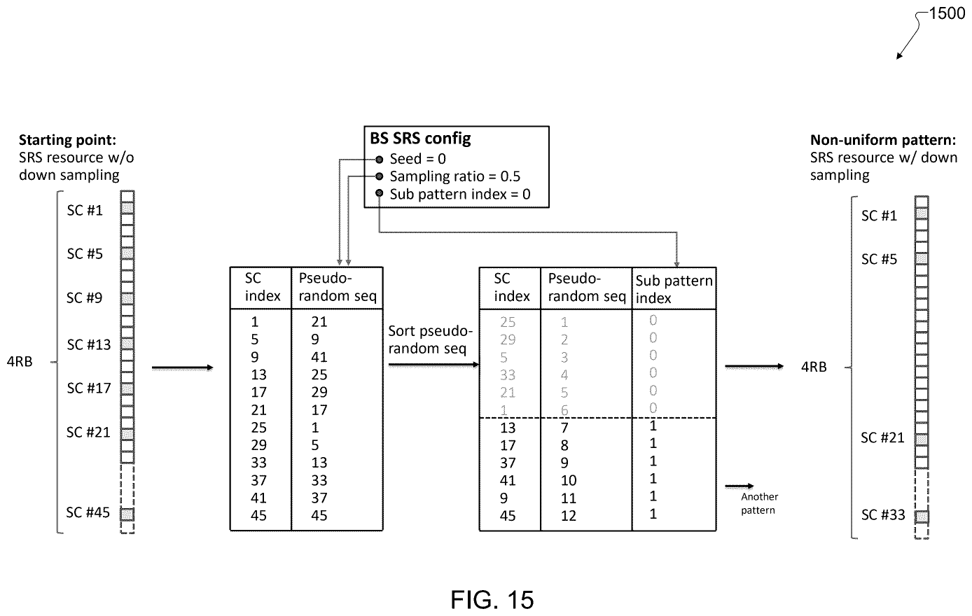

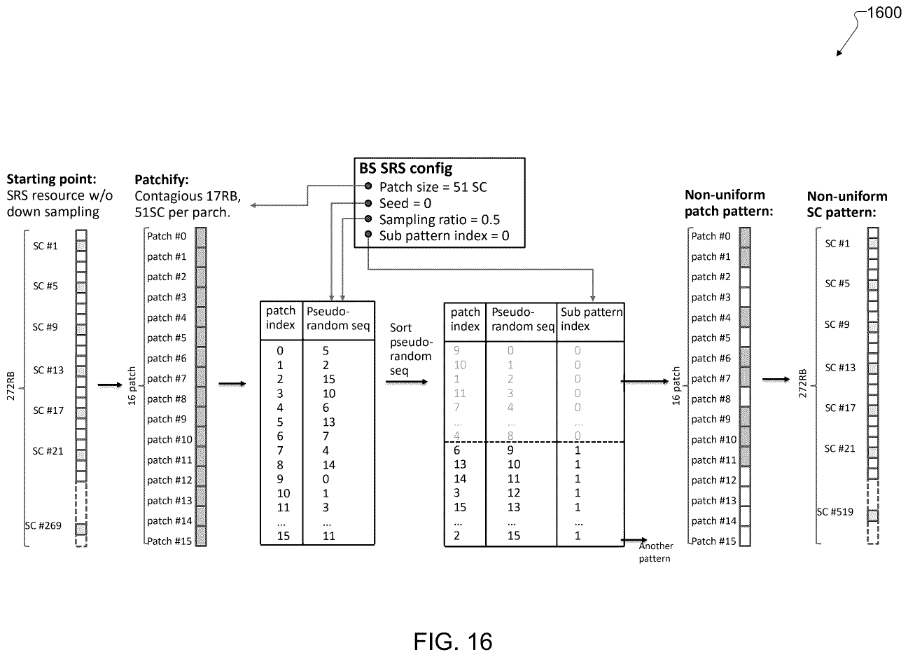

In some embodiments, the pseudo random pattern may be generated similar as described regarding one of FIG. 15 or FIG. 16.

At operation 1415, UE 1404 stores the SRS configuration (including the indication of the non-uniform pattern for SRS subsampling). For example, in some embodiments, the UE 1404 may store the SRS configuration in an SRS manager of UE 1404.

At operation 1420, an SRS scheduler of BS 1402 determines the SRS transmission and configuration of a particular UE (i.e., UE 1404).

At operation 1425, BS 1402 triggers or configures SRS transmission of a UE (i.e., UE 1404) configured with an SRS subsampling configuration. The SRS transmission may be configured in an aperiodic, semi-persistent, or periodic manner.

At operations 1430-1 through 1430-3, UE 1404 generates an SRS subsampling pattern according to the SRS configuration received from BS 702 at operation 710. For example, in some embodiments, at operation 1430-1, UE 1404 may generate a seed based on a slot ID, and may generate a pseudo random sequence by using the generated seed with a pseudo random sequence generator at operations 1430-2. At operation 1430-3, the UE may perform post processing on the generated random sequence.

At operation 1435, UE 1404 generates a subsampled SRS signal for transmission to BS 1402 based on the SRS subsampling pattern generated at operations 1430-1 through 1430-3.

At operation 1440, UE 1404 transmits the subsampled SRS signal generated at operation 1435 to BS 1402.

At operation 1445, BS 1402 extracts SRS from the subsampled SRS signal transmitted by UE 1404 at operation 1440 and performs channel estimation on the transmitted SRS resources.

At operation 1450, BS 1402 performs SRS CSI inpainting. For example, in some embodiments, BS 1402 may perform an AI-based inpainting such as masked-autoencoder, similar as described regarding FIG. 8. However, BS 1402 is not limited to any particular SRS CSI inpainting scheme or technique at operation 1450.

At operation 1455, BS 1402 obtains, from the SRS CSI inpainting at operation 1450, the full-band CSI of the antenna port of the UE (i.e., UE 1404) configured with an SRS subsampling configuration.

Although FIG. 14 illustrates one example procedure 1400 for AI-based SRS inpainting from a pseudo random non-uniform pattern, various changes may be made to FIG. 14. For example, while shown as a series of operations, various operations in FIG. 14 could overlap, occur in parallel, occur in a different order, occur any number of times, be omitted, or replaced by other operations.

FIG. 15 illustrates an example of pseudo random pattern generation for subcarrier level subsampling 1500 according to embodiments of the present disclosure. The embodiment of pseudo random pattern generation for subcarrier level subsampling of FIG. 15 is for illustration only. Different embodiments of pseudo random pattern generation for subcarrier level subsampling could be used without departing from the scope of this disclosure.

In the example of FIG. 15, a pseudo random sequence is mapped to the index of the sequence of non-subsampled subcarriers. The k-th subcarrier in the sequence of subcarriers is mapped to the k-th element in the pseudo random sequence. The pseudo random sequence is sorted and then split into multiple subsequences. For each subsequence, the corresponding subcarrier indexes comprise a subsampled SRS resource.

Although FIG. 15 illustrates one example of pseudo random pattern generation for subcarrier level subsampling 1500, various changes may be made to FIG. 15. For example, various changes to sampling ratio, the pseudo-random sequence could change, etc. according to particular needs.

FIG. 16 illustrates an example of pseudo random pattern generation for subband-level or patch level subsampling 1600 according to embodiments of the present disclosure. The embodiment of pseudo random pattern generation for subband-level or patch level subsampling of FIG. 16 is for illustration only. Different embodiments of pseudo random pattern generation for subband-level or patch level subsampling could be used without departing from the scope of this disclosure.

FIG. 16 illustrates an example similar to FIG. 15, except that the subcarriers are replaced by subbands. In the example of FIG. 16, a pseudo random sequence is mapped to the index of the sequence of non-subsampled subbands. The k-th subband in the sequence of subbands is mapped to the k-th element in the pseudo random sequence. The pseudo random sequence is sorted and then split into multiple subsequences. For each subsequence, the corresponding subband indexes comprise a subsampled SRS resource.

Although FIG. 16 illustrates one example of pseudo random pattern generation for subband-level or patch level subsampling 1600, various changes may be made to FIG. 16. For example, various changes to sampling ratio, the pseudo-random sequence could change, etc. according to particular needs.

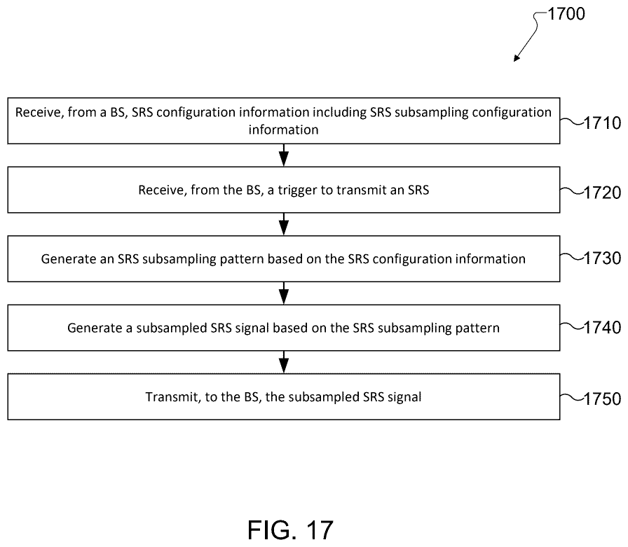

FIG. 17 illustrates an example method 1700 for SRS subsampling according to embodiments of the present disclosure. An embodiment of the method illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of a method for SRS subsampling could be used without departing from the scope of this disclosure.

In the example of FIG. 17, method 1700 begins at step 1710. At step 1710, a UE (such as UE 116 of FIG. 1) receives, from a BS (such as gNB 102 of FIG. 1), SRS configuration information. The SRS configuration includes SRS subsampling configuration information.

At step 1720, the UE receives, from the BS, a trigger to transmit an SRS.

In response to receiving the trigger to transmit the SRS, the UE performs steps 1730-50.

At step 1730, the UE generates an SRS subsampling pattern based on the SRS configuration information.

At step 1740, the UE generates a subsampled SRS signal based on the SRS subsampling pattern.

At step 1750, the UE transmits, to the BS, the subsampled SRS signal.

In some embodiments, the SRS configuration information may include configuration information for a non-uniform subsampling pattern. In these embodiments, the UE may generate the SRS subsampling pattern based on the configuration information for the non-uniform subsampling pattern. In some embodiments, the configuration information for the non-uniform subsampling pattern may include an indication of a seed for a pseudo random sequence. In these embodiments, to generate the SRS subsampling pattern, the UE may generate the pseudo random sequence based on the seed, and generate the SRS subsampling pattern based on the pseudo random sequence.

In some embodiments, the SRS configuration may include configuration information for a uniform subsampling pattern. In these embodiments, the UE may generate the SRS subsampling pattern based on the uniform subsampling pattern.

In some embodiments, the SRS configuration information may indicate subband-level SRS subsampling. In these embodiments, the UE may generate the SRS subsampling pattern based on subbands indicated by the SRS configuration information. In some embodiments, the SRS configuration information may indicates an SRS subsampling pattern with a variable subband density. In these embodiments, the UE may generate the SRS subsampling pattern based on subband densities indicated by the SRS configuration information.

In some embodiments, the SRS configuration information may indicate a comb based subsampling pattern. In these embodiments, the UE may generate the SRS subsampling pattern based on a comb indicated by the SRS configuration information.

Although FIG. 17 illustrates one example method for 1700 for SRS subsampling, various changes may be made to FIG. 17. For example, while shown as a series of steps, various steps in FIG. 17 could overlap, occur in parallel, occur in a different order, occur any number of times, be omitted, or replaced by other steps.

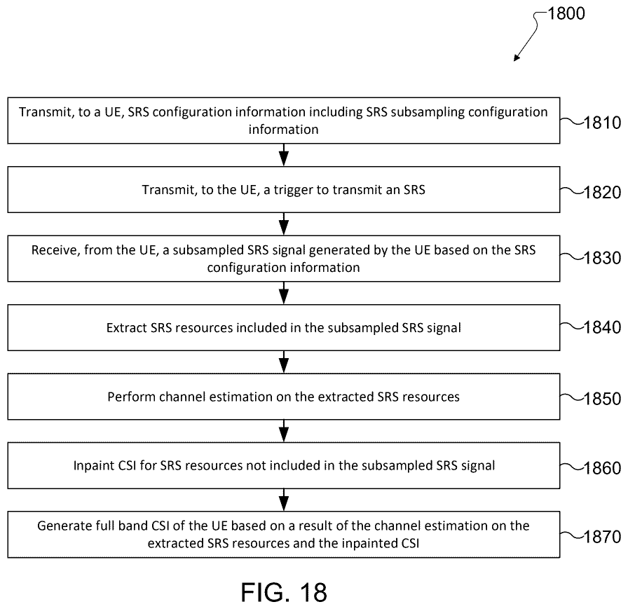

FIG. 18 illustrates an example method 1800 for SRS subsampling and inpainting according to embodiments of the present disclosure. An embodiment of the method illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of a method for SRS subsampling and inpainting could be used without departing from the scope of this disclosure.

In the example of FIG. 18, method 1800 begins at step 1810. At step 1710, a BS (such as gNB 102 of FIG. 1) transmits, to a UE (such as UE 116 of FIG. 1), SRS configuration information. The SRS configuration includes SRS subsampling configuration information.

At step 1820, the BS transmits, to the UE, a trigger to transmit an SRS.

At step 1830, the BS receives, form the UE, a subsampled SRS signal generated by the UE based on the SRS configuration information.

At step 1840, the BS extracts SRS resources included in the subsampled SRS signal.

At step 1850, the BS performs channel estimation on the extracted SRS resources.

At step 1860, the BS inpaints CSI for SRS resources not included in the subsampled SRS signal. In some embodiments, to inpaint the CSI for the SRS resources not included in the SRS subsampled signal, the BS may input the result of the channel estimation into a trained MAE model (for example, MAE 800 of FIG. 8), and may receive the inpainted CSI as output from the MAE model.

At step 1870, the BS generates full band CSI of the UE based on a result of the channel estimation on the extracted SRS resources and the inpainted CSI.

In some embodiments, the SRS configuration information may include configuration information for a non-uniform subsampling pattern. In these embodiments, the subsampled SRS signal generated by the UE may be generated based on the configuration information for the non-uniform subsampling pattern. In some embodiments, the configuration information for the non-uniform subsampling pattern may include an indication of a seed for a pseudo random sequence. In these embodiments, the subsampled SRS signal generated by the UE may be generated based on the pseudo random sequence.

In some embodiments, the SRS configuration information may include configuration information for a uniform subsampling pattern. In these embodiments, the subsampled SRS signal generated by the UE may be generated based on the uniform subsampling pattern.

In some embodiments, the SRS configuration information may indicate subband-level SRS subsampling. In these embodiments, the subsampled SRS signal generated by the UE may be generated based on subbands indicated by the SRS configuration information. In some embodiments, the SRS configuration information may indicate an SRS subsampling pattern with a variable subband density. In these embodiments, the subsampled SRS signal generated by the UE may be generated based on subband densities indicated by the SRS configuration information.

In some embodiments, the SRS configuration information may indicate a comb based subsampling pattern. In the embodiments, the subsampled SRS signal generated by the UE may be generated based on a comb indicated by the SRS configuration information.

Although FIG. 18 illustrates one example method for 1800 for SRS subsampling and inpainting, various changes may be made to FIG. 18. For example, while shown as a series of steps, various steps in FIG. 18 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a base station (BS), sounding reference signal (SRS) configuration information, the SRS configuration information including SRS subsampling configuration information; and
receive, from the BS, a trigger to transmit an SRS; and
a processor operably coupled to the transceiver, the processor configured to, in response to receipt of the trigger to transmit the SRS:
generate an SRS subsampling pattern based on the SRS configuration information;
generate a subsampled SRS signal based on the SRS subsampling pattern; and
cause the transceiver to transmit, to the BS, the subsampled SRS signal.

2. The UE of claim 1, wherein the SRS configuration information includes configuration information for a non-uniform subsampling pattern, and the processor is further configured to generate the SRS subsampling pattern based on the configuration information for the non-uniform subsampling pattern.

3. The UE of claim 2, wherein the configuration information for the non-uniform subsampling pattern includes an indication of a seed for a pseudo random sequence, and to generate the SRS subsampling pattern, the processor is further configured to:
generate the pseudo random sequence based on the seed; and
generate the SRS subsampling pattern based on the pseudo random sequence.

4. The UE of claim 1, wherein the SRS configuration information includes configuration information for a uniform subsampling pattern, and the processor is further configured to generate the SRS subsampling pattern based on the uniform subsampling pattern.

5. The UE of claim 1, wherein the SRS configuration information indicates subband-level SRS subsampling, and the processor is further configured to generate the SRS subsampling pattern based on subbands indicated by the SRS configuration information.

6. The UE of claim 5, wherein the SRS configuration information indicates an SRS subsampling pattern with a variable subband density, and the processor is further configured to generate the SRS subsampling pattern based on subband densities indicated by the SRS configuration information.

7. The UE of claim 1, wherein the SRS configuration information indicates a comb based subsampling pattern, and the processor is further configured to generate the SRS subsampling pattern based on a comb indicated by the SRS configuration information.

8. A base station (BS) comprising:
a transceiver configured to:
transmit, to a user equipment (UE), sounding reference signal (SRS) configuration information, the SRS configuration information including SRS subsampling configuration information; and
transmit, to the UE, a trigger to transmit an SRS; and
receive, from the UE, a subsampled SRS signal generated by the UE based on the SRS configuration information; and
a processor operably coupled to the transceiver, the processor configured to:
extract SRS resources included in the subsampled SRS signal;
perform channel estimation on the extracted SRS resources;
inpaint channel state information (CSI) for SRS resources not included in the subsampled SRS signal; and
generate full band CSI of the UE based on a result of the channel estimation on the extracted SRS resources and the inpainted CSI.

9. The BS of claim 8, wherein to inpaint the CSI for SRS resources not included in the SRS subsampled signal, the processor is further configured to:
input the result of the channel estimation into a trained masked-autoencoder (MAE) model, and
receive the inpainted CSI as output from the MAE model.

10. The BS of claim 8, wherein the SRS configuration information includes configuration information for a non-uniform subsampling pattern, and the subsampled SRS signal generated by the UE is generated based on the configuration information for the non-uniform subsampling pattern.

11. The BS of claim 10, wherein the configuration information for the non-uniform subsampling pattern includes an indication of a seed for a pseudo random sequence, and the subsampled SRS signal generated by the UE is generated based on the pseudo random sequence.

12. The BS of claim 8, wherein the SRS configuration information includes configuration information for a uniform subsampling pattern, and the subsampled SRS signal generated by the UE is generated based on the uniform subsampling pattern.

13. The BS of claim 8, wherein the SRS configuration information indicates subband-level SRS subsampling, and the subsampled SRS signal generated by the UE is generated based on subbands indicated by the SRS configuration information.

14. The BS of claim 13, wherein the SRS configuration information indicates an SRS subsampling pattern with a variable subband density, and the subsampled SRS signal generated by the UE is generated based on subband densities indicated by the SRS configuration information.

15. The BS of claim 8, wherein the SRS configuration information indicates a comb based subsampling pattern, and the subsampled SRS signal generated by the UE is generated based on a comb indicated by the SRS configuration information.

16. A method of operating a user equipment (UE), the method comprising:
receiving, from a base station (BS), sounding reference signal (SRS) configuration information, the SRS configuration information including SRS subsampling configuration information;
receiving, from the BS, a trigger to transmit an SRS; and
in response to receipt of the trigger to transmit the SRS:
generating an SRS subsampling pattern based on the SRS configuration information;
generating a subsampled SRS signal based on the SRS subsampling pattern; and
transmitting, to the BS, the subsampled SRS signal.

17. The method of claim 16, wherein the SRS configuration information includes configuration information for a non-uniform subsampling pattern, and the SRS subsampling pattern based is generated based on the configuration information for the non-uniform subsampling pattern.

18. The method of claim 16, wherein the SRS configuration information includes configuration information for a uniform subsampling pattern, and the SRS subsampling pattern is generated based on the uniform subsampling pattern.

19. The method of claim 16, wherein the SRS configuration information indicates subband-level SRS subsampling, and the SRS subsampling pattern is generated based on subbands indicated by the SRS configuration information.

20. The method of claim 16, wherein the SRS configuration information indicates a comb based subsampling pattern, and the SRS subsampling pattern is generated based on a comb indicated by the SRS configuration information.
